(19) United States
(12) Patent Application Publication
(10) Pub. No.: US 2012/0162252 A1
(43) Pub. Date: Jun. 28, 2012

(54) IMAGE OUTPUT APPARATUS AND IMAGE OUTPUT CONTROL METHOD

(75) Inventor: Norio ENDO, Fuchu-shi (JP)

(73) Assignee: CASIO COMPUTER CO., LTD., Tokyo (JP)

(21) Appl. No.: 13/336,572

(22) Filed: Dec. 23, 2011

(30) Foreign Application Priority Data
Dec. 27, 2010 (JP) 2010-290867
Sep. 5, 2011 (JP) 2011-192493

(51) Int. Cl. G09G 5/00

(52) U.S. Cl. 345/629

(57) ABSTRACT

When an arbitrary shot image has been selected from shooting-location-information-attached shot images and a map representation form corresponding to the intended use (e.g., sightseeing priority, railroad priority, or shop priority) has been set, various objects (including mountains, rivers, roads, and buildings) included in the map are selectively drawn according to the level of importance of the set intended use. The selected shot image is superimposed on the map according to its shooting location. In addition, a plurality of change data items are prepared for each object on the map. The representation form is changed to a different representation form according to a user operation.

### CROSS-REFERENCE TO RELATED APPLICATIONS

This application is based upon and claims the benefit, of priority from prior Japanese Patent Applications No. 2010-290867, filed Dec. 27, 2010; and No. 2011-192493, filed Sep. 5, 2011, the entire contents of all of which are incorporated herein by reference.

### BACKGROUND OF THE INVENTION

1. Field of the Invention

This invention relates to an image output apparatus which superimposes, for example, a photographic image taken by the user on a map in such a manner that the image corresponds to its shooting location and displays the resulting image and an image output control method for the image output apparatus.

2. Description of the Related Art

A digital camera with a global positioning system (GPS) function has been put to practical use. A digital camera that displays not only a shot image but also a map based on information on its shooting location is under consideration.

An image output apparatus that displays a photographic image taken with a GPS-function-equipped digital camera together with a map related to the shooting location of the image has been proposed in, for example, Jpn. Pat. Appln. KOKAI Publication No. 2004-48560.

Generally, map data that includes geographic features, including mountains and rivers, transportation facilities, including roads and railroads, and buildings, including public facilities and commercial facilities, has been represented in the form of symbols determined in the field of maps. If map data including urban areas and complex land forms is output directly to the outside, the map is accurate, but has the problem of lacking eye-friendliness because it includes even unnecessary information to some users (e.g., narrow streets or small buildings).

### BRIEF SUMMARY OF THE INVENTION

An image output apparatus and an image output control method for the apparatus according to an embodiment of the invention enables a photographic image and simplified map data expected by the user to be combined and output.

An image output apparatus according to an embodiment of the invention comprises a data storage module which stores drawing data on each object constituting a map for each area of the map, an object importance level storage module which stores the importance level of each object stored by the data storage module for each of predetermined map types, a shot image storage module which stores a shot image together with its shooting location information, a type specify module which specifies one of the predetermined map types according to a user operation, a map creation module which selectively acquires drawing data on each object from the data storage module according to the importance level of a map type specified by the type specify module and creates a map image, a map superimposition module which superimposes a shot image stored in the shot image storage module on a map image created by the map creation module in such a manner that the shot image corresponds to its shooting location, and an image output module which outputs an map image on which the shot image has been superimposed by the image superimposition module.

An image output apparatus according to another embodiment of the invention comprises a data storage module which stores drawing data on each object constituting a map for each area of the map, a map creation module which acquires drawing data on each object constituting the map from the data storage module and creates a map image, an image output module which outputs an map image created by the map creation module, an object specify module which specifies, according to a user operation, an arbitrary object included in a map image output by the image output module, and a representation form change module which changes the representation form of an object specified by the object specify module to a different representation form according to a user operation.

Additional objects and advantages of the invention will he set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of the electronic circuit of a camera-equipped mobile terminal 10 with a GPS function according to an embodiment of an image output apparatus of the invention;

FIG, 2 is a table showing the contents of map data object attribute DB 16M stored in a data storage module 16 of the camera-equipped mobile terminal 10;

FIG. 3 shows a user request dialog D displayed on a touch panel display module 25 in outputting map data according to a map superimposition process by the camera-equipped mobile terminal 10;

FIG. 4 is a flowchart to explain a map superimposition process (1) of a first embodiment by the camera-equipped mobile terminal 10;

FIG. 5 is a diagram showing the operation of displaying map data resulting from the map superimposition process (1) of the first embodiment by the camera-equipped mobile terminal 10;

FIG. 6 is a flowchart to explain a map superimposition process (2) of a second embodiment by the camera-equipped mobile terminal 10;

FIG. 7 is a diagram showing the operation of displaying map data resulting from the map superimposition process (2) of the second embodiment by the camera-equipped mobile terminal 10;

FIG. 8 shows the contents of modification option data caused to correspond to each object ID of the map data object attribute DB 16M;

FIG. 9 shows a concrete example of an image list file that stores various items of drawing image data on rivers constituting map data;

FIG. 10 shows a concrete example of deforming drawing data on rivers constituting map data to modify the data; and

FIG. 11 is a flowchart, to explain, in detail, a display change process (steps S17 to S20) included in the map superimposition processes (1) and (2) of the first and second embodiments in FIGS. 4 and 6.

### DETAILED DESCRIPTION OF THE INVENTION

Hereinafter referring to the accompanying drawings, embodiments, of the invention will be explained.

### First Embodiment

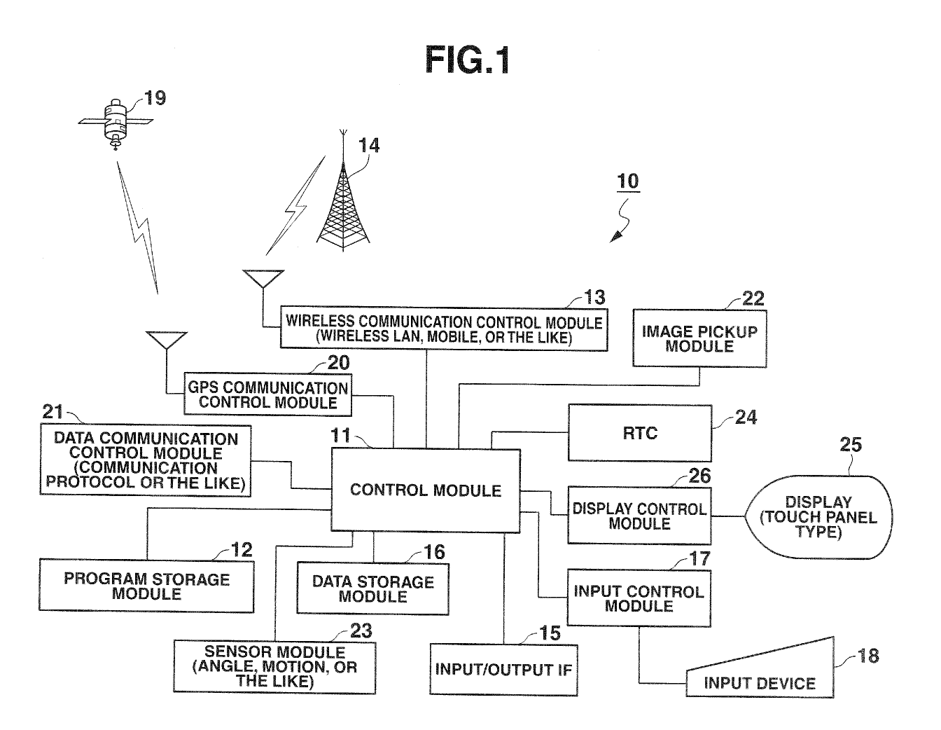

FIG. 1 is a block diagram showing a configuration of the electronic circuit of a camera-equipped mobile terminal 10 with a GPS function according to an embodiment of an image output apparatus of the invention.

The camera-equipped mobile terminal 10 with the GPS function comprises a control module (CPU) 11 acting as a computer. The control module (CPU) 11 controls each part of the circuit using a data storage module 16 as a work area according to a terminal control program previously stored in a program storage module 12, a terminal control program downloaded from a program server (not shown) on a communication network 14 via wireless communication control module 13, or a terminal control program read from an external memory (not shown) via an input/output interface (e.g., USB) 15,

The terminal control program is activated by a signal corresponding to a user operation input from an input device 18, such as a keyboard or a touch panel, via an input control module 17.

Connected to the control module 11 are the program storage module 12, wireless communication module 13, input/output interface 15, data storage module 16, and input control module 17. Further connected to the control module 11 are a data communication control module 21 that converts or analyzes a communication protocol when communicating with the outside via a GPS communication control module 20 or the wireless communication control module 13, an image pickup module 22 that performs shooting according to a shooting instruction from the input device 18, a sensor module 23 with an angle (direction) sensor or a motion sensor, a real time counter (RTC) 24 that times the present time, and a display control module 26 that controls the display operation of a touch panel display module 25.

Stored as the terminal control program are not only a communication control program for telephones and mail but also a shooting control program for the image pickup module 22, a shot image storage control program, a shot image display control program, a map data display/edit control program, a map data and shot image superimposition control program, and others.

Each item of shot image data taken by the image pickup module 22 is caused to correspond to position information sensed by the GPS communication control module 20 at the time of shooting, direction (lengthwise/breadthwise) information sensed by the angle sensor of the sensor module 23, and date and time information measured by the RTC 24. Then, the resulting data is stored in the data storage module 16.

In the data storage module 16, map data (base data that includes position information excluding obi cots) and drawing data (vector image) on objects (mountains/rivers/roads/railroads/building and others) constituting the image data are sectionalized by a specific area on a map and the resulting data is stored. Attribute information about objects for each of the sectionalized map data items is stored in a map data object attribute database 16M (see FIG. 2).

Map data items sectionalized by the specific area are assigned respective map IDs and managed. Object drawing data items on the map data are also assigned respective object IDs and managed.

FIG. 2 is a table showing the contents of map data object attribute DB 16M stored in the data storage module 16 of the camera-equipped mobile terminal 10.

In the map data object attribute DB 16M, object IDs indicating the individual object drawing data items in the map data and names of the individual objects (object names) are caused to correspond to map IDs and stored. In addition, the level of importance is stored according to the type of use of each object as follows: the level of importance as a general map (map importance level), the level of importance as a sightseeing map (sightseeing importance level), the level of importance as a railroad map (railroad importance level), the level of importance as a commercial map (store importance level), and others.

Specifically, as for map importance level, in the case of roads, the level of importance of national roads, expressways, and the like is set high and that of prefectural highways, public roads, and the like is set low. In addition, as for sightseeing importance level, in the case of parks, the level of importance of quasi-national parks, municipal parks, and the like is set high and that of ward parks, small town parks, and the like is set low.

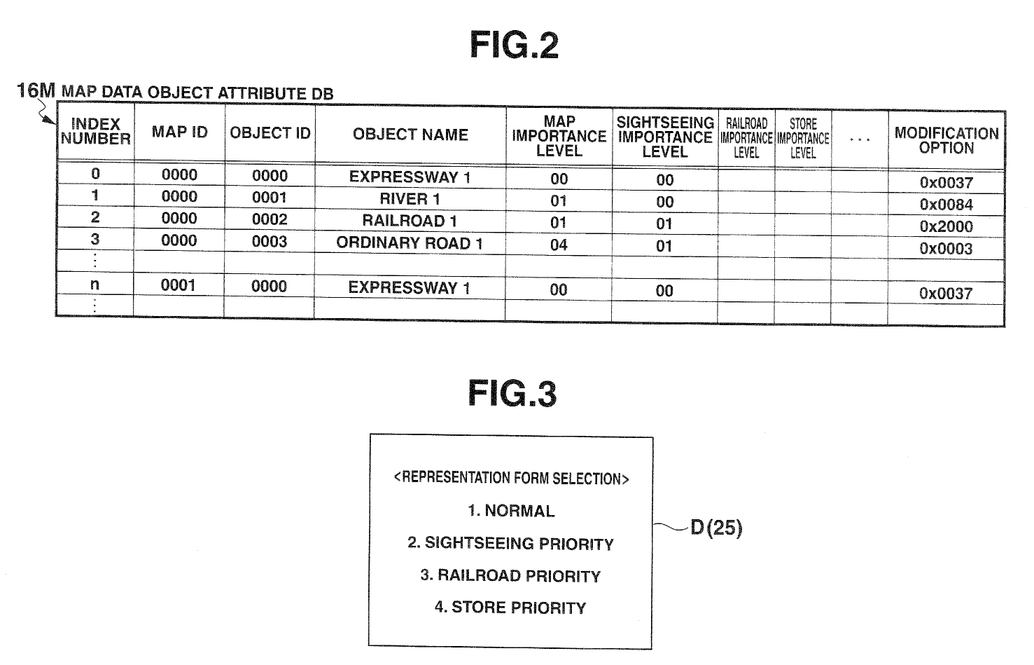

The highest level of importance of an object is represented by “00.” When map data is output, what use is prioritized is set according to a user request dialogue D described later (see FIG. 3). In addition, as the reduction scale of a map becomes larger, the superimposition of an object on map data is omitted in ascending order of importance of the object.

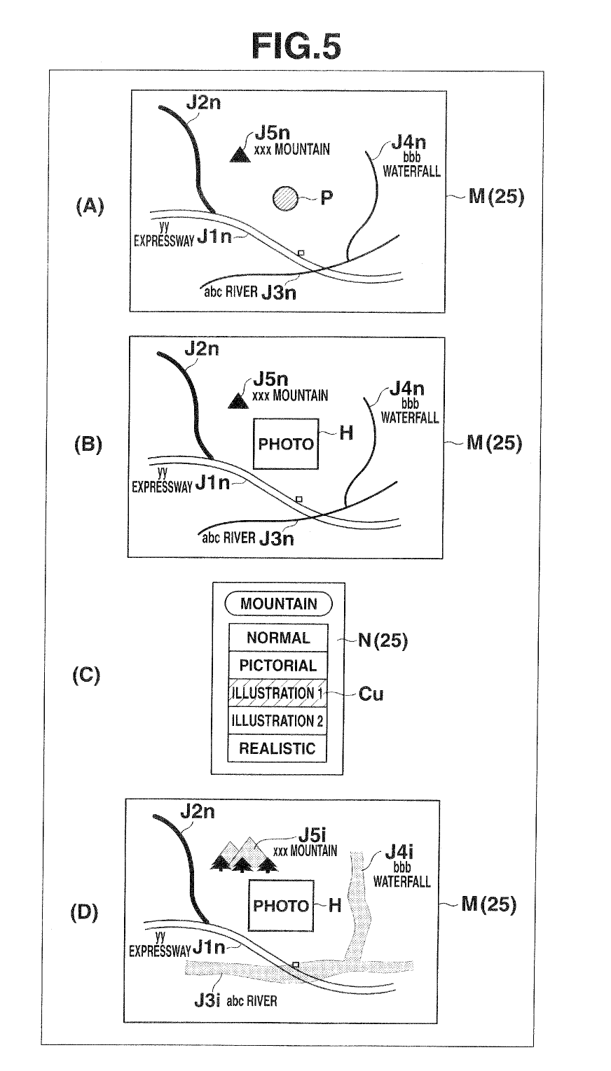

Furthermore, a modification option to change the representation form of the relevant, object to another representation form is stored so as to correspond to each ID object. The representation forms of objects include a normal representation form as a map, a pictorial representation form, an illustrative representation form, and a realistic representation form. When map data is output, the representation forms can be changed according to a change menu described later (see (C) in FIG. 5). Therefore, drawing data corresponding to various representation toms has been prepared as object drawing data stored in the data storage module 16 so as to correspond to each object. ID.

FIG. 3 shows a user request dialog D displayed on the touch panel display module 25 in outputting map data from the camera-equipped mobile terminal 10.

The user request dialog D is a screen that prompts the user to select a display form of map data according to use of the map. For example, if [1. Normal] has been selected, each object on the map data is selectively superimposed according to [Map importance level] set in the map data object attribute DB 16M. If [2. Sightseeing priority] has been selected, each object on the map data is selectively superimposed according to [Sightseeing importance level] set in the map data object attribute DB 16M.

In the camera-equipped mobile terminal 10 configured as described above, the control module (CPU) 11 controls the operation of each part of the circuit according to instructions written in the terminal control programs (including the shooting control program, shot image storage control program, shot image display control program, map data display/edit control program, map data and shot image superimposition control program) so as to cause software and hardware to cooperate with each other in operation, thereby realizing functions described below.

Next, a map superimposition and output operation of the camera-equipped mobile terminal 10 with the GPS function configured as described above will be explained.

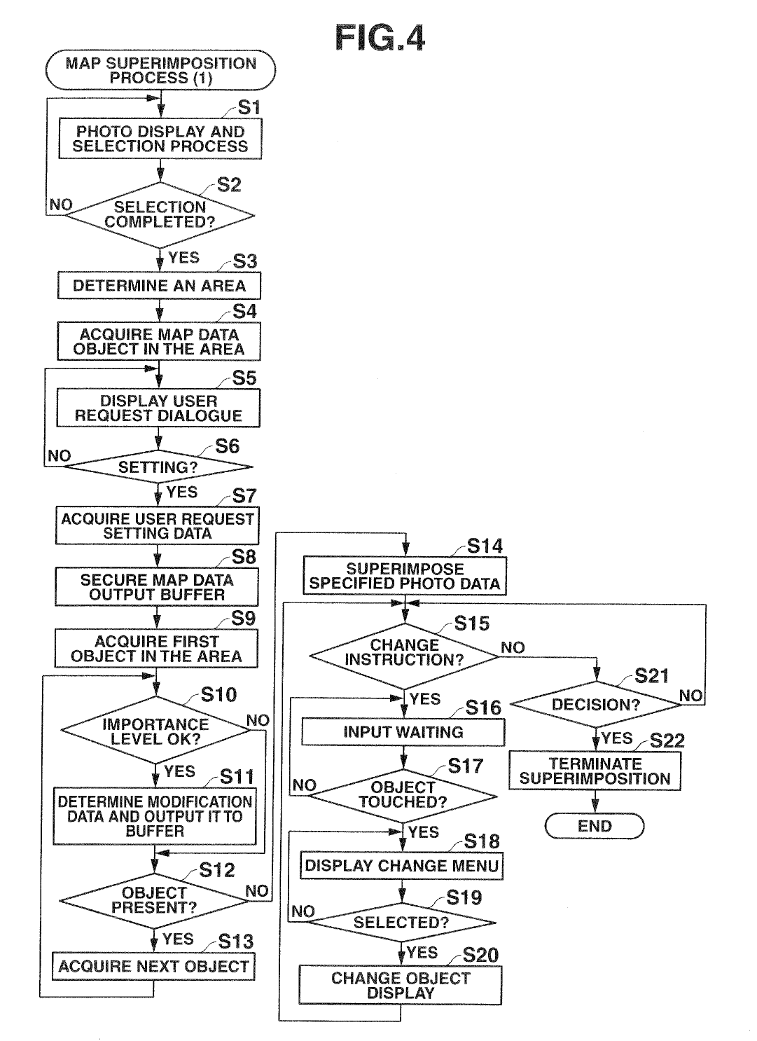

FIG. 4 is a flowchart to explain a map superimposition process (1) of the first embodiment by the camera-equipped mobile terminal 10.

FIG. 5 is a diagram showing the operation of displaying map data resulting from the map superimposition process (1) of the first embodiment by the camera-equipped mobile terminal 10.

Each shot image data item taken by the user with the image pickup module 22 set in a camera mode is stored in the data storage module 16 so as to correspond to position information detected by the GPS communication control module 20 at the time of shooting each of the images, direction (lengthwise/breadthwise) information sensed by the angle sensor of the sensor module 23, and date and time information measured by the RTC 24.

When a map data superimposition output mode has been set and map superimposition process (1) of FIG. 4 has been activated, various shot image data items stored in the data storage module 16 are read and displayed on the touch panel display module 25, being switched sequentially according to a key operation on the input module 18 (step S1).

When a Decision key is operated, with an arbitrary shot image data item being selected and displayed (Yes in step S2), an area of the map data is determined according to position information caused to correspond to the selected shot image data item (step S3). Next, a map ID of the map data item of the determined area and an object ID of each object included in the map data item are acquired (step S4).

Then, as shown in FIG. 3, a user request dialogue D is displayed on the touch panel display module 25 (step S5).

When a display form corresponding to the intended use (e.g., [2. Sightseeing priority]) has been touched according to the user request dialogue D (Yes in step S6), the set user request [Sightseeing priority] is acquired (step S7) and an output buffer into which map image data is to be written is secured in the data storage module 16 (step S6).

Then, after map data corresponding to the acquired map ID in step S4 has been written into the output buffer, the first object [Sightseeing importance level] stored in the map data object attribute DB 16M (see FIG. 2) so as to correspond to the map ID is acquired (step S9) and it is determined whether the [Sightseeing importance level] is not lower than a preset level (e.g., “02”) (step S10).

If it has been determined that [Sightseeing importance level] of the object acquired this time is not less than the preset level “02” (Yes In step S10), object drawing data corresponding to the object ID is read and is additionally written to the map data written in the output buffer (step S11). At this time, if a modification option has been set, the object is written in the set representation form. In the case of default, drawing data in [Normal] representation form is written.

If it has been determined that [Sightseeing importance level] of the object acquired this time (e.g., a private house object) is less than the preset level “02” (No in step S10), the object is not drawn on the map data and is omitted.

Then, if it has been determined that the next object caused to correspond to the map ID exists (Yes in step S12), [Sightseeing importance level] of the next object is acquired (step S13) and it is determined in the same manner as last time whether the [Sightseeing importance level] is not less than the preset level (e.g., “02”) (step S10). After this, the processes in steps S10 to S13 are repeated as described above and only object drawing data items not less than level “02” as [Sightseeing importance level] are selectively read in sequence and drawn on the map data written in the output buffer. As a result, for example, as shown by (A) in FIG. 5, map data M suitable for sightseeing in an area corresponding to shooting location P of the shot image selected by the user is created and displayed on the touch panel display module 25.

In map data M shown by (A) in FIG. 5, J1n indicates an expressway, J2n an ordinary road, J3n and J4n rivers, and J5n a mountain. All of these are shown in the normal representation form by default.

After map data M suitable for the user's intended use of an area corresponding to shooting location P of the shot image has been created in this way, the selected shot image data H is superimposed on the shooting location P and displayed as shown by (B) in FIG. 5 (step S14).

Here, when the user wants to change the present normal representation form of the object drawn on the map data M to another representation form, the user gives a change instruction from the input module 18. If it has been determined that a change instruction has been input (Yes in step S15), the terminal device 10 goes into an input waiting state to specify an object to be changed on map data M (step S16).

For example, as shown by (B) in FIG. 5, mountain object J5n is touched and specified in the displayed map data P (Yes in step S17), a change menu N for the representation form of the specified mountain object is displayed (step S18) as shown by (C) in FIG. 5.

According to the change menu N, when the representation form desired by the user (e.g., [Illustration 1] illustration style (part 1)) is touched and selected (Yes in step S19), object drawing data J5i of the illustration style (part 1) stored so as to correspond to the mountain object ID is read, replaces the mountain object. J5n in the normal representation form, and is displayed as shown by (D) in FIG. 5 (step S20).

Similarly, when an instruction to change the object representation form has been input (Yes in step S15) and river objects J3n, J4n have been touched and specified as shown by (B) in FIG. 5 (Yes in steps S16, S17), a change menu N for the representation form of the specified river objects is displayed (step S18).

When the representation form desired by the user has been touched and selected according to the change menu N (Yes in step S19), object drawing data items J3i, J4i in the selected representation form stored so as to correspond to the specified river object IDs are read, replace the river objects J3n, J4n in the normal representation form as shown by (D) in FIG. 5, and are displayed (step S20).

Then, when the decision key on the input device 18 is operated (Yes in step S21), the series of map superimposition processes (1) is completed (step S22).

Accordingly, with the map superimposition output function of the first embodiment, when a shot image has been selected and the display form of map data according to the intended use (i.e., sightseeing priority, railroad priority, store priority, or the like) has been set, each object (i.e., mountain, river, road, building, or the like) is selected according to the level of importance set by use and displayed on map data on an area corresponding to the shooting location.

Therefore, not only can shot image data H be superimposed on map data M in the area corresponding to the shooting location P and be output, but also each object included in the map data M can be simplified to an object with a higher level of importance according to the user's intended use at the time of drawing. Therefore, the user can create map data M easy to use in, for example, writing a blog, preparing materials, or the like.

In addition, drawing data on each object included in the map data M can be changed to drawing data corresponding to various representation forms in such a manner that, for example, drawing data in the normal representation form is changed to an illustrative representation form or a pictorial representation form.

Therefore, image data M of a design to the user's taste can be obtained easily.

### Second Embodiment

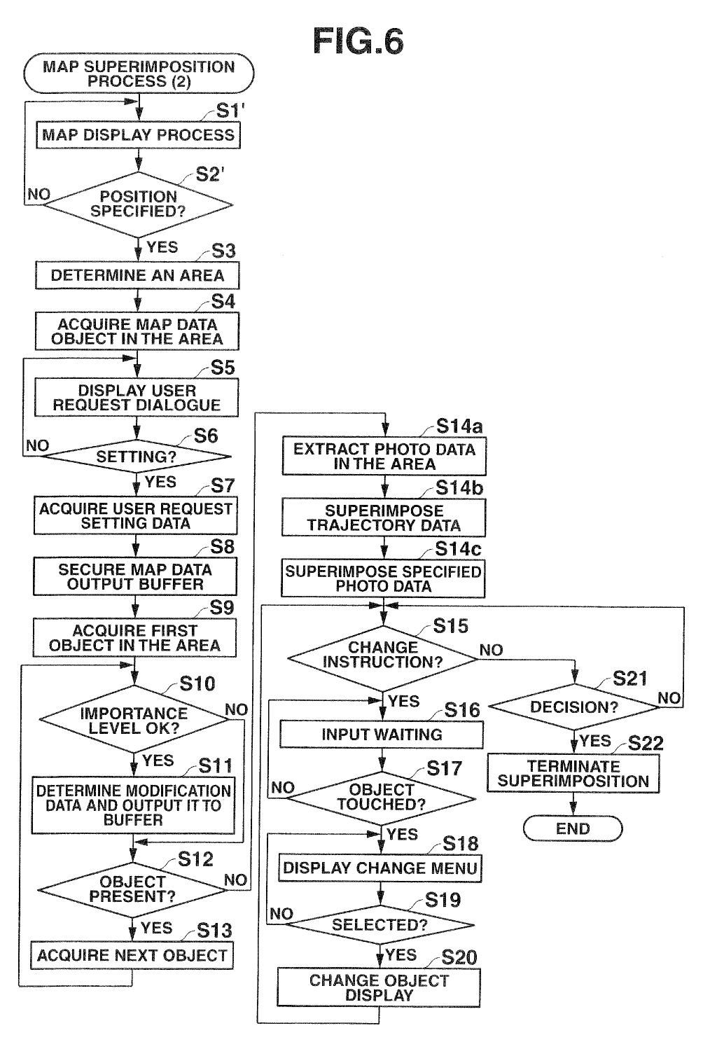

FIG. 6 is a flowchart to explain a map superimposition process (2) of a second embodiment by the camera-equipped mobile terminal 10.

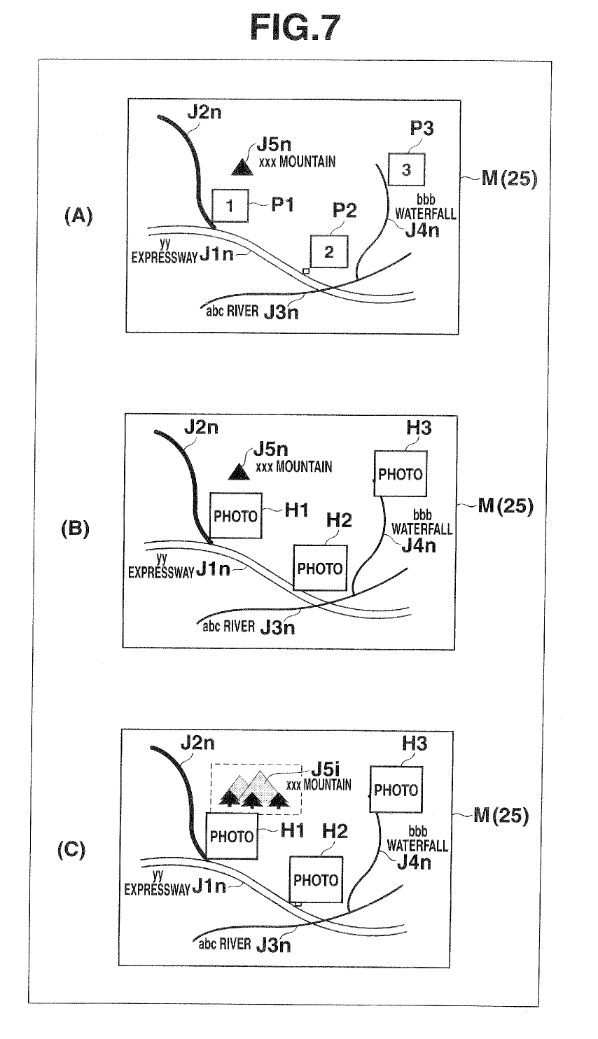

FIG. 7 is a diagram showing the operation of displaying map data resulting from the map superimposition process (2) of the second embodiment by the camera-equipped mobile terminal 10.

In the map superimposition process (2) of the second embodiment, the same processing steps as those in the map superimposition process (1) of the first embodiment of FIG. 4 will be indicated by the same reference numerals as those in the first embodiment in the explanation below.

When a map data superimposition output mode has been set and a map superimposition process (2) of FIG. 6 has been activated, for example, wide-area map data stored in a data storage module 16 is read and displayed on a touch panel display module 25 (step S1′).

When the user touches an arbitrary position (place) to specify the position (Yes in step S2′), an area of the map data is determined according to position information on the specified position (place) (step S3). Then, a map ID of the map data on the determined area and an object ID of each object included in the map data are acquired (step S4).

Then, as shown in FIG. 3, a user request dialogue D is displayed on the touch panel display module 25 (step S5).

When a display form corresponding to the intended use (e.g., [1. Normal]) has been touched according to the user request dialogue D (Yes in step S6), the set user request [Normal] is acquired (step S7) and an output buffer into which map image data is to be written is secured in the data storage module 16 (step S8).

Then, after map data corresponding to the acquired map ID in step S4 has been written in the output buffer, the first object [Map importance level] stored in a map data object attribute DB 16M (see FIG. 2) so as to correspond to the map ID is acquired (step S9) and it is determined whether the [Map importance level] is not less than a preset level (e.g., “02”) (step S10).

If it has been determined that [Map importance level] of the object acquired this time is not less that the preset level “02” (Yes in step S10), object drawing data corresponding to the object ID is read and is additionally written to the map data written in the output buffer (step S11). At this time, if a modification option has been set, the object is written in the set representation form. In the case of default, drawing data in [Normal] representation form is written.

If it has been determined that [Map importance level] of the object acquired this time (e.g., an object of ordinary road 1) is less than the preset level “02” (No in step S10), the object is riot drawn on the map data and is omitted.

Then, if it has been determined that the next object ID caused to correspond to the map ID exists (Yes in step S12), [Map importance level] of the next object is acquired (step S13) and it is determined in the same manner as last time whether the [Map importance level] is not less than the preset level (e.g., “02”) (step S10).

After this, the processes in steps S10 to S13 are repeated as described above, only object drawing data items not less than level “02” as [Map importance level] are selectively read in sequence and drawn on the map data written in the output buffer. As a result, for example, as shown by (A) in FIG. 7, map data M suitable for normal use of an area corresponding to the user-specified position (place) is created and displayed on the touch panel display module 25.

At this moment, in map data M shown by (A) in FIG. 7, photo shoot trajectory data items P1, P2, . . . . have not been displayed yet.

When map data M suitable for the use's intended use of an area corresponding to the user-specified position (place) has been created and displayed, each shot image data item stored so as to correspond to a piece of position information included in the area of map data M is extracted (step S14a).

Then, according to information on shooting locations and shooting dates and times attached to the extracted individual shot image data items, trajectory data items P1, P2, P3 in the order of shooting locations of and in the order of shooting of the individual shot image data items are created, superimposed on the map data 5, and displayed (step 114b).

Then, for each of shooting trajectory data items P1, P2, P3 on the map data M, shot image data items H1, H2, H3 are specified arbitrarily by the user from a plurality of shot image data items corresponding to the shooting locations and are superimposed on the corresponding shooting locations as shown by (B) in FIG. 7 (step S14c). At this time, the image size of shot image data items H1, H2, H3 specified for shooting trajectory data items P1, P2, P3 respectively can be enlarged or reduced as needed and be superimposed on the map data.

Here, as in the map superimposition process (1) of first embodiment, when the user wants to change the present normal representation form of an object drawn on the map data M to another representation form, if the user gives a change instruction from the input module 18 (Yes in step S15), the terminal device 10 goes into an input waiting state to specify an object to be changed on map data M (step S16).

For example, as shown by (B) in FIG. 7, in map data M where shot images H1, H2, H3 have been superimposed on their respective shooting locations and displayed, when mountain object J5n drawn in the normal representation form is touched and specified (Yes in step S17), a change menu N (see (C) in FIG. 5) for the representation form of the specified mountain object is displayed (step S18).

According to the change menu N, when the representation form desired by the user is selected (Yes in step S19), object drawing data J5i in the selected representation form stored so as to correspond to the object ID of the mountain is read, replaces the mountain object J5n in the normal representation form as shown by (C) in FIG. 7, and is displayed (step S20).

Then, when the decision key on the input device 18 is operated (Yes in step S21), the series of map superimposition processes (2) is completed (step S22).

Accordingly, with the map superimposition and output function of the second embodiment, each shot image stored so as to correspond to position information included in an area of the created map data M is extracted. From shooting location information and shooting date and time information, shooting trajectory data items P1, P2, P3 are created, superimposed on the map data H, and displayed. When arbitrary shot images H1, H2, H3 that have the relevant pieces of shooting location information are specified for the respective shooting trajectory data items P1, P2, P3 on the map data M, the specified shot images H1, H2, H3 are superimposed on the respective shooting locations and displayed on the touch panel display module 25.

In addition, when the user specifies an object the representation form of which the user wants to change on the map data M display on the touch panel display module 25 and selects a desired representation form from the representation form change menu N, the specified object is replaced with drawing data in the selected representation form and the output.

Next, an object display change process in the map superimposition and output function of the camera-equipped mobile terminal 10 of the first and second embodiments (steps S17 to S20) will be explained in more detail.

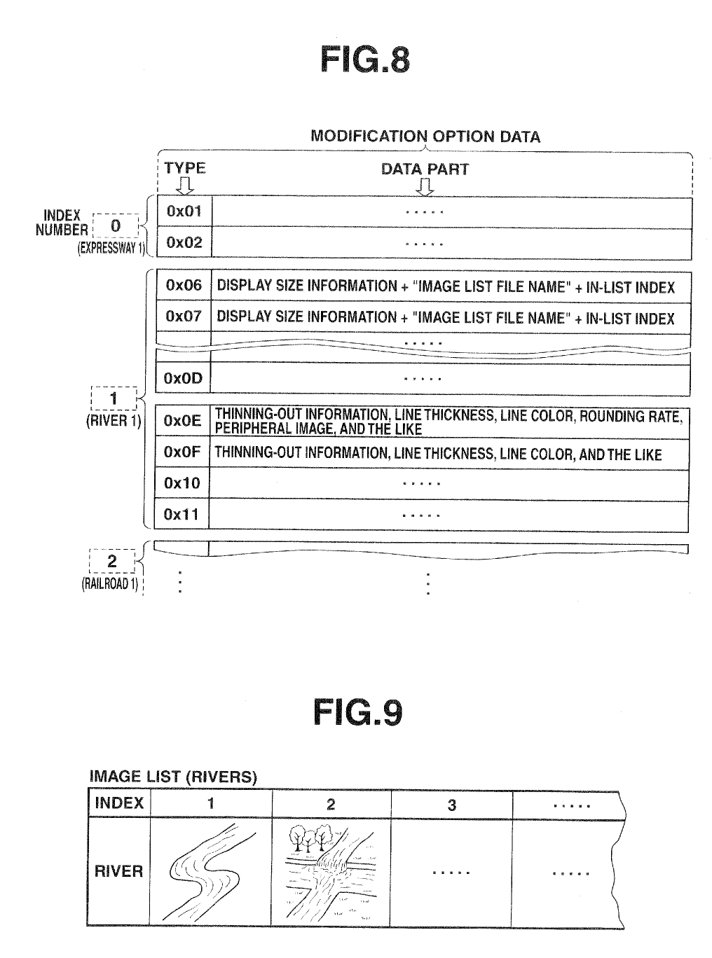

FIG. 8 shows the contents of modification option data caused to correspond to the individual object IDs of the map data object attribute DB 16M.

In the modification option data, a modification type code of a corresponding object and data representing the modification content are written so to correspond to each index number in the map data object attribute DB 16M of FIG.

For example, a modification option corresponding to Index number “1,” object ID “0001,” object name

“River 1” in FIG. 2 will be explained. The modification option code “0x0084” indicates that eight types of drawing image data to be attached to the display range of “River 1” as modification option data to change the display form of “River 1” and four types of deformation data to deform normal drawing data (vector image) on “River 1” have been prepared.

Then, modification option data as shown in FIG. 8 is prepared so as to correspond to Index number “1.” In the modification option data, display size information on a corresponding type of drawing image data, the name of an image list file in which the drawing image data has been stored, and an in-list index are written as modification contents so as to correspond to type codes “0x06 to 0x0D.” In addition, coordinate data thinning-out information (thinning-out rate) to deform normal drawing data (vector image) on “River 1” and such data items as the thickness of a line to be drawn, the color of line, the line corner rounding rate, and additional peripheral images are combined and written so as to correspond to type codes “0x0E to 0x11.” The modification option data enables twelve representation forms to be selected in addition to normal map drawing data.

FIG. 9 shows a concrete example of an image list file that stores various items of drawing image data on rivers constituting map data.

In the image list file (river), a plurality of types of drawing image data items representing rivers in different forms have been stored so as to correspond to individual indexes.

Specifically, when any one of type codes “0x06 to 0x0D” indicating eight types of drawing image data of the modification option data corresponding to object “River 1” in FIG. 8 has been selected, for example, an drawing image data item in the image list file (river) shown in FIG. 9 is determined and attached to the display range of a river object specified on the map data M currently being displayed.

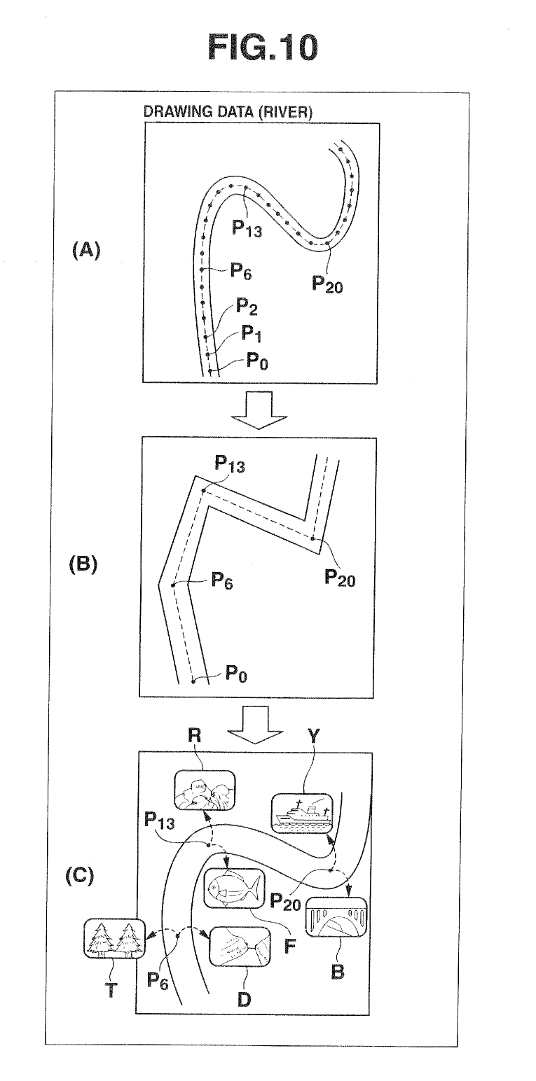

FIG. 10 shows a concrete example of deforming drawing data on rivers constituting map data to modify the data.

When any one of type codes “0x0E to 0x11” indicating four types of deformation data of the modification option data corresponding to object “River 1” in FIG. 8 has been selected, for example, an drawing image data item (vector image) on rivers as shown by (A) in FIG. 10 is deformed by a line redrawing process after coordinate thinning-out as shown by (B) in FIG. 10, a line corner rounding process as shown by (C) in FIG. 10, and a peripheral image adding process according to deformation data (coordinate thinning-out information, line thickness, color, corner rounding rate, additional peripheral images, and others) written as modification content data for the selected type code.

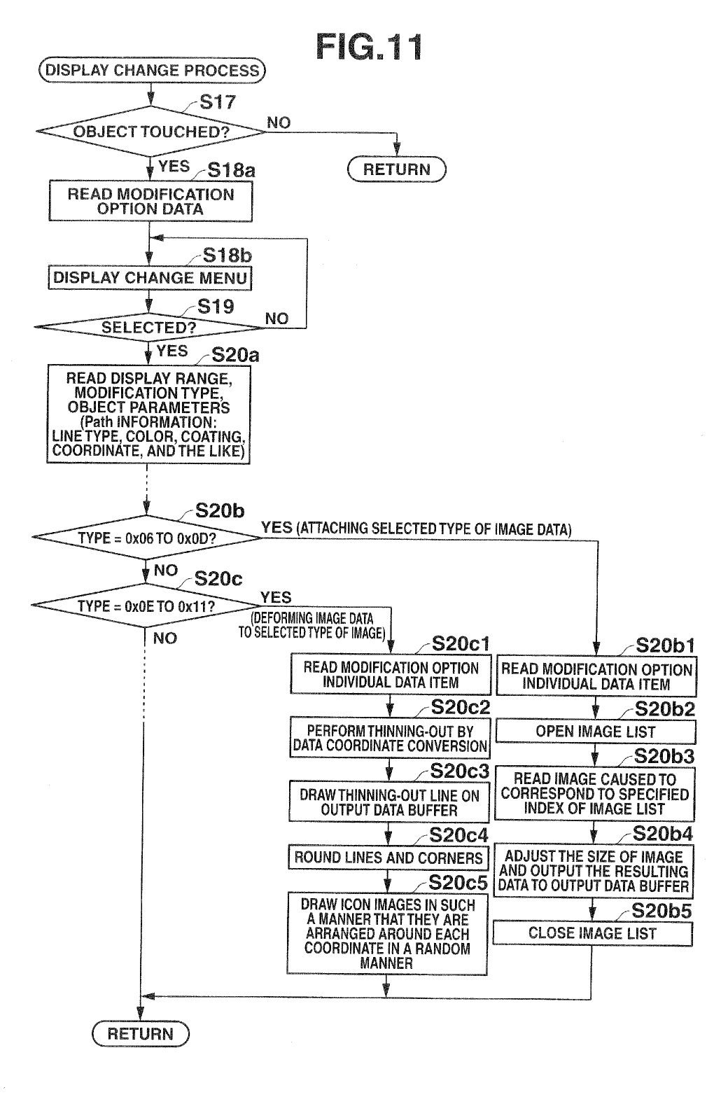

FIG. 11 is a flowchart to explain, in detail, a display change process (steps S17 to S20) included in the map superimposition processes (1) and (2) of the first and second embodiments in FIGS. 4 and 6.

For example, as shown by (B) in FIG. 5, in an input waiting state for specifying an object to be changed on map data M (step S16), when river object J3n drawn in the normal representation form is touched and specified (Yes in step S17), modification option data (see FIG. 8) corresponding to the specified river object (e.g., “River 1”) is read (step S18a) and a change menu N (see (C) in FIG. 5) that enables twelve representation forms to be selected is displayed (step S18b).

When a representation form desired by the user has been selected from the change menu N (Yes in step S19), a display range, a modification type, object parameters (coordinate information on vector data, line type, color, coating, and others) corresponding to drawing data (vector image) on rivers in the normal representation form specified as an object to be changed are read (step S20a).

Then, it is determined whether the type code of the modification option data (see FIG. 8) selected as a representation form to be changed is in the range of “0x06” to “0x0D” (change by the attachment of drawing image data) (step S20b) or of “0x0E” to “0x11” (change by the deformation of drawing image data) (step S20c).

If it has been determined that the type code corresponding to the representation form of the selected “River 1” is “0x06” (Yes in step S20b), modification content data (display size information on drawing image data, the name of an image list file in which the drawing image data has been stored, and an in-list index) corresponding to the selected type code “0x06” are read (step S20b1).

Then, according to the read image list file name and the in-list index, an image list (rivers) with the image list file name (see FIG. 9) is opened (step S20b2) and drawing image data stored in such a manner as to correspond to the specified index is read (step S20b3).

Then, drawing image data read from the image list (rivers) is adjusted according to the display range of drawing data in the normal representation form whose size has been selected as a change object and is developed on the output data buffer (step S20b4).

As a result, drawing data J3n on a river in the normal representation form selected as the change object is replaced with drawing image data in another representation form selected by the user this time. Then, the resulting data is displayed.

After this, the image list (river) (see FIG. 9) is closed and the present display object (river) changing process is terminated (step S20b5).

On the other hand, if it has been determined that the type code corresponding to the representation form of “River 1” selected according to the change menu N is “0x0E” (Yes in step S20c), modification content data (including coordinate thinning-out information, line thickness, color, corner rounding rate, and additional peripheral images) corresponding to the selected type code “0x0E” is read (step S20c1).

Then, the coordinates of vector data read as an object parameter of drawing data on the river in the normal representation form selected as the change object is subjected to a thinning-out process according to coordinate thinning-out information read as the modification content data (step S20c2) and a line segment corresponding to vector data after coordinate thinning-out is redrawn on the output data buffer as shown by, for example, (A) (B) in FIG. 10 (step S20c3). At this time, according to the line thickness and color read as the modification content data, the thickness and color of the line segment redrawn after the present coordinate thinning-out are adjusted according to the line thickness and color read as the modification content data.

In addition, the line segment redrawn this time and its corner part are rounded into a natural arc according to a corner rounding rate read as the modification content data as shown by, for example, (C) in FIG. 10 (step S20c4).

Furthermore, as shown by (C) in FIG. 10, images T (tree), D (bank), R (rock), F (fish), Y (ship), B (bridge) related to a river are drawn according to the additional peripheral images read as the modification content data so as to be arranged in a random manner near individual coordinate points Pn, . . . after the coordinate thinning-out (step S20c5).

As a result, drawing data J3n on a river in the normal representation form selected as the change object is deformed into another representation form selected by the user this time.

While in the object display changing process, a concrete example of changing the representation form of drawing data on a river has been explained, the process of changing the representation form of drawing data on another object can be performed in the same manner.

The methods of the individual processes by the camera-equipped mobile terminal 10 written in the embodiments, including the map superimposition process (1) of the first embodiment shown in the flowchart of FIG. 4, the map superimposition process (2) of the second embodiment shown in the flowchart of FIG. 6, and the display changing process accompanying the map superimposition processes (1), (2) of the first and second embodiments, can be stored in an external storage medium (not shown), such as a memory card (e.g., a ROM card or a RAM card.), a magnetic disk (e.g., a floppy disk or a hard disk.), an optical disk (e.g., a CD-ROM or a DVD), or a semiconductor memory, in the form of programs a computer can execute. Then, the mediums can be delivered. The computer of a camera-equipped electronic device with a GPS function reads the program stored in the external storage medium into a storage device (12). The computer is controlled by the read-in program, thereby realizing the function of superimposing map data corresponding to the user's intended use on image data taken on the same map explained in the first and second embodiments and outputting the resulting data, which enables the same processes in the aforementioned methods to be carried out.

Furthermore, the data of the programs which realize the above methods can be transferred in the form of program code through a network (14). The program data can be loaded into the computer of the camera-equipped electronic device with the GPS function connected to the network (14) through the communication control module (13), thereby realizing the function of superimposing map data corresponding to the user's intended use on image data taken on the same map and outputting the resulting data

Additional advantages and modifications will readily occur to those skilled in the art. Therefore, the invention in its broader aspects is not, limited to the specific details and representative embodiments shown and described herein. Accordingly, various modifications may be made without departing from the spirit or scope of the general inventive concept as defined by the appended claims and their equivalents.

What is claimed is:

1. An image output apparatus comprising:
a data storage module which stores drawing data on each object constituting a map for each area of the map;
an object importance level storage module which stores the importance level of each object stored by the data storage module for each of predetermined map types;
a shot image storage module which stores a shot image together with its shooting location information;
a type specify module which specifies one of the predetermined map types according to a user operation;
a map creation module which selectively acquires drawing data on each object from the data storage module according to the importance level of a map type specified by the type specify module and creates a map image;
a image superimposition module which superimposes a shot image stored in the shot image storage module on a map image created by the map creation module in such a manner that the shot image corresponds to its shooting location; and
an image output module which outputs an map image on which the shot image has been superimposed by the image superimposition module.

2. The image output apparatus of claim 1, further comprising:
a shot image selection module which selects, according to a user operation, a shot image stored by the shot image storage module, and
an area determination module which determines a map area in which shooting location information on the shot image selected by the shot image selection module is included,
wherein the map creation module acquires drawing data on each object in the determined area from the data storage module.

3. The image output apparatus of claim 2, further comprising:
an object specify module which specifies, according to a user operation, an arbitrary object included in a map image output by the image output module, and
a representation form change module which changes the representation form of an object specified by the object specify module to a different representation form according to a user operation.

4. The image output apparatus of claim 3, further comprising a change data storage module which stores a plurality of types of image data differing in the representation form of a corresponding object for each object stored in the data storage module,
wherein the representation form change module replaces an object specified by the object specify module with image data selected according to a user operation from the image data stored by the change data storage module to change to a different representation form.

5. The image output apparatus of claim 3, further comprising a change data storage module which stores a plurality of types of change data for deforming drawing data on a corresponding object for each object stored by the data storage module,
wherein the representation form change module deforms drawing data on an object specified by the object specify module according to change data selected according to a user operation from the change data stored by the change data storage module to change to a different representation form.

6. The image output apparatus of claim 1, further comprising:
a map position specify module which specifies a map position;
an area determination module which determines a map area in which a position specified by the map position specify module is included; and
a shot image extraction module which extracts a shot image having information on a shooting location included in the map area determined by the area determination module from the shot images stored in the shot image storage module,
wherein the map creation module acquires drawing data on each object included in the map area determined by the area determination module from the data storage module, and
the image superimposition module superimposes a shot image extracted by the shot image extraction module on the created map image in such a mariner that the shot image corresponds to its shooting location.

7. The image output apparatus of claim 6, further comprising:
an object specify module which specifies, according to a user operation, an arbitrary object included in a map image output by the image output module; and
a representation form change module which changes the representation form of the object specified by the object specify module to a different representation form according to a user operation.

8. The image output apparatus of claim 7, further comprising a change data storage module which stores a plurality of types of image data differing in the representation form of a corresponding object for each object stored by data storage module,
wherein the representation form change module replaces an object specified by the object specify module with image data selected according to a user operation from the image data stored by the change data storage module to change to a different representation form.

9. The image output apparatus of claim 7, further comprising a change data storage module which stores a plurality of types of change data for deforming drawing data on a corresponding object for each object stored by the data storage module,
wherein the representation form change module deforms drawing data on an object specified by the object specify module according to change data selected according to a user operation from the change data stored by the change data storage module to change to a different representation form.

10. An image output apparatus comprising:
a data storage module which stores drawing data on each object constituting a map for each area of the map;
a map creation module which acquires drawing data on each object constituting the map from the data storage module and creates a map image;
an image output module which outputs an map image created by the map creation module;
an object specify module which specifies, according to a user operation, an arbitrary object included in a map image output by the image output module; and
a representation form change module which changes the representation form of an object specified by the object specify module to a different representation form according to a user operation.

11. The image output apparatus of claim 10, further comprising a change data storage module which stores a plurality of types of image data differing in the representation form of a corresponding object for each object stored in the data storage module,
wherein the representation form change module replaces an object specified by the object specify module with image data selected according to a user operation from the image data stored by the change data storage module to change to a different representation form.

12. The image output apparatus of claim 10, further comprising a change data storage module which stores a plurality of types of change data for deforming drawing data on a corresponding object for each object stored by the data storage module,
wherein the representation form change module deforms drawing data on an object specified by the object specify module according to change data selected according to a user operation from the change data stored by the change data storage module to change to a different representation form.

13. The image output apparatus of claim 10, further comprising:
an object importance level storage module which stores the importance level of each object stored by the data storage module for each of predetermined map types;
a shot image storage module which stores a shot image together with its shooting location information;
a type specify module which specifies one of the predetermined map types according to a user operation; and
a map superimposition module which superimposes a shot image stored by the shot image storage module on a map image created by the map creation module in such a manner that the shot image corresponds to its shooting location,
wherein the map creation module selectively acquires drawing data on each object from the data storage module according to the importance level of a map type specified by the type specify module.

14. An image output control method in an electronic device which stores drawing data on each object constituting a map in a memory for each area of the map, the image output control method comprising:
acquiring drawing data on each object constituting a map from the memory and creating a map image;
outputting the created map image;
specifying an arbitrary object included in the output map image according to a user operation; and
changing the representation form of the specified object to a different representation form according to a user operation.

15. The image output control method of claim 14, wherein the memory stores a plurality of types of image data differing in the representation form of a corresponding object for each object, and
the changing the representation form of the object includes replacing the specified object with image data selected according to a user operation from the image data stored in the memory to change to a different representation form.

16. The image output control method of claim 14, wherein the memory stores a plurality of types of change data for deforming drawing data on a corresponding object for each object, and
the changing the representation form of the object includes deforming drawing data on the specified object according to change data selected according to a user operation from the change data stored in the memory to change to a different representation form.

17. The image output control method of claim 14, wherein the memory stores importance level data on each object for each predetermined type and shot image data having shooting location information, and
the creating a map image includes selectively acquiring drawing data on each object constituting map from the memory according to the importance level of each object of a type specified according to a user operation, creating a map image, and superimposing the shot image stored in the memory on the created map image in such a manner that the shot image corresponds to its shooting location.
